(19) United States
(12) Patent Application Publication
(10) Pub. No.: US 2024/0229978 A1
(43) Pub. Date: Jul. 11, 2024

(54) DUCT STRUCTURE

(71) Applicant: HONDA MOTOR CO., LTD., Tokyo (JP)

(72) Inventor: Daigo KOMATSU, Tokyo (JP)

(73) Assignee: HONDA MOTOR CO., LTD., Tokyo (JP)

(21) Appl. No.: 18/405,398

(22) Filed: Jan. 5, 2024

(30) Foreign Application Priority Data
Jan. 6, 2023 (JP) 2023-000828

(51) Int. Cl. F16L 9/00; F16L 9/21; H01M 10/613; H01M 10/625; H01M 10/6563

(52) U.S. Cl. CPC F16L 9/006; F16L 9/21; H01M 10/613; H01M 10/625; H01M 10/6563; H01M 2220/20

(57) ABSTRACT

A duct structure includes: a duct member, wherein the duct member includes: an introduction portion, an opening communicating with a fan, a curved flow path having the opening and extending in a curved shape, a rectifying portion rectifying the cooling air flowing through the curved flow path, and a guide portion provided in the opening and guiding the cooling air flowing through the curved flow path to the opening, a sound absorbing material is provided in the curved flow path, the guide portion includes a guide wall, and an inlet is disposed at a position that is not visible in a plane perpendicular to a rotation axis direction of the fan when viewed in a direction perpendicular to a virtual line connecting one side end portion and the other side end portion of the guide wall from the opening in a straight line.

### CROSS-REFERENCE TO RELATED APPLICATIONS

This application is based on and claims priority under 35 USC 119 from Japanese Patent Application No. 2023-000828 filed on Jan. 6, 2023, the entire content of which is incorporated herein by reference.

### TECHNICAL FIELD

The present invention relates to a duct structure connected to a fan that blows cooling air to a battery mounted on a vehicle.

### BACKGROUND ART

In recent years, researches and developments have been conducted on a secondary battery (also referred to as a battery) that contributes to improvement in energy efficiency in order to allow more users to access affordable, reliable, sustainable, and advanced energy.

With electrification of a drive source of a vehicle, the vehicle is equipped with a battery that supplies power to a motor and the like. Since the battery generates heat when supplying power or being charged, the vehicle is also equipped with a devices for cooling the battery. For example, JP2006-228556A describes a cooling structure in which a cooling fan blows cooling air to a secondary battery to cool the secondary battery.

While the cooling fan is operating, wind noise of the cooling fan and motor noise may leak into an interior of the vehicle as noise. JP2006-228556A describes a configuration in which a cooling air passage having at least one bend is provided between an air vent and the cooling fan in order to reduce the noise of the cooling fan.

Specifically, in JP2006-228556A, a main duct forming the cooling air passage has an approximately L-shape bent at approximately 90°, and the main duct connects the fan disposed below and a tank portion positioned above. At a bent portion in the main duct, the noise from the cooling fan is reflected by an inner wall of the main duct, so that the noise can be attenuated before reaching the air vent.

### SUMMARY OF INVENTION

Although JP2006-228556A describes a configuration in which the noise of the cooling fan is reduced by the bent portion of the main duct, there may be cases where the noise reduction is insufficient. There is room for improvement in a duct member in order to improve noise reduction performance.

The present invention provides a duct structure that can sufficiently reduce noise generated by a fan within a duct member. By extension, this contributes to improvement in energy efficiency.

According to the present invention, the noise generated by the fan can be sufficiently reduced within the duct member.

### BRIEF DESCRIPTION OF DRAWINGS

FIG. 1 is a perspective view of a battery pack 1 equipped with an intake duct 13, which is an embodiment of a duct structure of the present invention;

FIG. 2 is an exploded perspective view of the battery pack 1;

FIG. 3 is a perspective view of an intake duct 13 connected to a fan 12:

FIG. 4 is a perspective view of a downstream duct member 40 viewed from below;

FIG. 5 is a top view of the downstream duct member 40;

FIG. 6 is a cross-sectional view taken along a line A-A in FIG. 5, showing a structure of a rectifying portion 420;

FIG. 7 is a diagram schematically showing how noise generated by the fan 12 travels into a curved flow path 410 by a guide portion 430; and

FIG. 8 is a top view of the downstream duct member 40, and is a diagram schematically showing how the noise generated by the fan 12 is guided to the curved flow path 410 by the guide portion 430 and travels inside the curved flow path 410.

### DESCRIPTION OF EMBODIMENTS

Hereinafter, one embodiment of a duct structure of the present invention will be described based on the accompanying drawings. Note that the drawings are viewed in directions of reference numerals. In the present description and the like, in order to simplify and clarify the description, a front-rear direction, a left-right direction, and an upper-lower direction are described according to directions viewed from a driver of a vehicle. In the drawings, a front side of the vehicle is shown as Fr, a rear side is shown as Rr, a left side is shown as L, a right side is shown as R, an upper side is shown as U, and a lower side is shown as D.

### Battery Pack

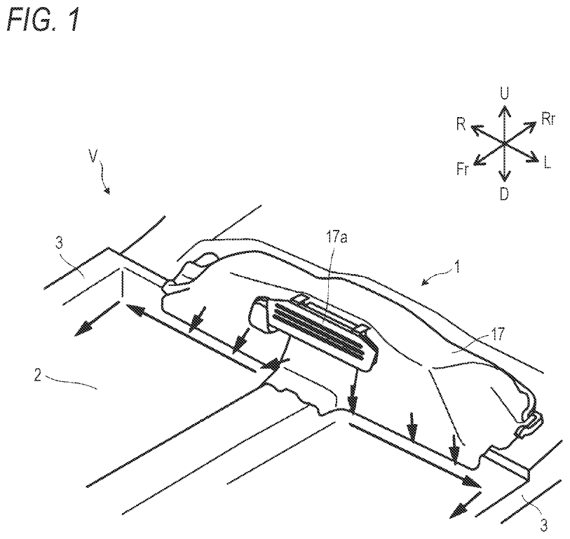

First, a battery pack 1 equipped with an intake duct 13, which is an embodiment of the duct structure of the present invention, will be described. As shown in FIG. 1, the battery pack 1 is mounted on a vehicle V. The vehicle V is an electric vehicle such as a hybrid vehicle or an electric automobile, and is able to travel by driving a motor using electric power stored in the battery pack 1. The battery pack 1 is placed on a floor panel 2 and fixed to the floor panel 2 between a pair of left and right skeleton frame members 3 extending along the front-rear direction. The floor panel 2 constitutes floors of a vehicle interior and a luggage compartment, and a rear seat (not shown) is disposed above the battery pack 1.

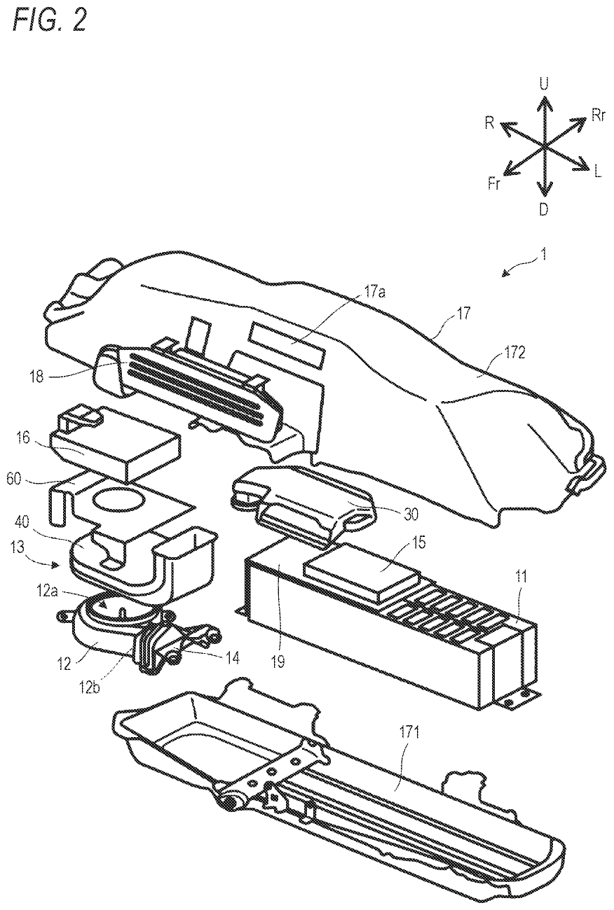

As shown in FIG. 2, the battery pack 1 includes a battery module 11, a fan 12, an intake duct 13, a blower duct 14, and a battery electronic control unit (ECU) 15, a junction board 16, and a battery case 17 that accommodates these members.

The battery case 17 includes a base plate 171 and a cover 172 that covers the base plate 171 from above. The battery module 11, the fan 12, and the blower duct 14 are placed on the base plate 171. The cover 172 covers the base plate 171 and is fixed to the floor panel 2. An intake port 17a is formed on a front surface of the cover 172, and the intake port 17a is covered with a ventilated grille 18.

The battery module 11 has a substantially rectangular parallelepiped shape that is long in a vehicle width direction, and is fixed to the base plate 171. The battery module 11 includes a plurality of battery cells stacked in the vehicle width direction. An inter-cell flow path (not shown) is formed between adjacent battery cells, and the battery module 11 is cooled by cooling air sent out from the blower duct 14 flowing through the inter-cell flow path.

The fan 12 is fixed to base plate 171. The fan 12 is, for example, a sirocco fan. The fan 12 sucks the cooling air through a suction port 12a provided in a rotation axis direction (upper-lower direction in the present embodiment), and blows out the cooling air from a blow-out port 12b provided in a centrifugal direction to the blower duct 14.

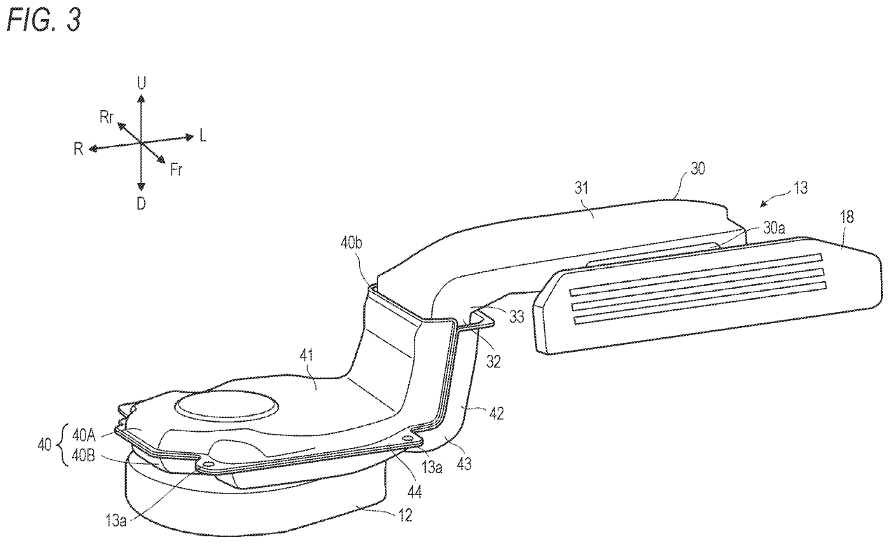

The intake duct 13 connects an intake port 17a provided on the cover 172 and the suction port 12a of the fan 12, as shown in FIGS. 2 and 3. The intake duct 13 guides air in the vehicle interior as the cooling air from the intake port 17a to the fan 12.

The intake duct 13 includes an upstream duct member 30 and a downstream duct member 40. The upstream duct member 30 is connected to the intake port 17a and is disposed above the battery module 11. The downstream duct member 40 is connected to the suction port 12a of the fan 12 and is disposed on the right side of the battery module 11. Details of the intake duct 13 will be described later.

The blower duct 14 is provided between the battery module 11 and the fan 12, and is connected to the blow-out port 12b of the fan 12. The blower duct 14 sends out the cooling air blown out from the blow-out port 12b along a lower surface of the battery module 11. The cooling air sent out below the battery module 11 flows through the inter-cell flow path from the lower side to the upper side so as to cool the battery module 11, and is discharged from an upper surface of the battery module 11. Thereafter, the cooling air flows inside the battery case 17 and is discharged to the outside of the battery case 17 as indicated by the arrows in FIG. 1.

The battery ECU 15 controls charging and discharging of the battery module 11. The battery ECU 15 is mounted on a bracket 19 attached to the battery module 11 and is disposed between the upstream duct member 30 and the battery module 11. The battery ECU 15 includes a processor, a memory, an interface, and the like.

The junction board 16 electrically connects the battery module 11 and external equipment (not shown), and includes wiring components through which charging power and discharging power of the battery module 11 flow. The junction board 16 is disposed above the downstream duct member 40 and on the right side of the upstream duct member 30. The junction board 16 is mounted on a bracket 60 provided above the downstream duct member 40.

### Intake Duct

Next, details of the intake duct 13 will be described with reference to FIGS. 3 to 8.

The intake duct 13 is provided inside the battery pack 1 mounted on the vehicle V, as described above. The intake duct 13 connects the intake port 17a and the fan 12 of the battery pack 1.

As shown in FIG. 3, the intake duct 13 includes the upstream duct member 30 and the downstream duct member 40. The upstream duct member 30 and the downstream duct member 40 are connected to each other by inserting an end portion of the upstream duct member 30 into an end portion of the downstream duct member 40 from above.

The upstream duct member 30 is a substantially L-shaped duct when viewed from the front side. The upstream duct member 30 is made of resin, for example. The upstream duct member 30 is provided with an intake port connection portion 30a which opens forward, and the intake port connection portion 30a is connected to the intake port 17a from the inside of the cover 172.

The upstream duct member 30 includes a horizontal portion 31, a vertical portion 32, and a bent portion 33. The horizontal portion 31 extends in a horizontal direction along the upper surface of the battery module 11. The vertical portion 32 extends in a vertical direction along a right surface of battery module 11. A lower end of the vertical portion 32 is opened downward and connected to the downstream duct member 40. The bent portion 33 connects the horizontal portion 31 and the vertical portion 32. The bent portion 33 changes a traveling direction of the cooling air flowing in the horizontal portion 31 from the horizontal 5 direction to the vertical direction, and guides the cooling air to the vertical portion 32.

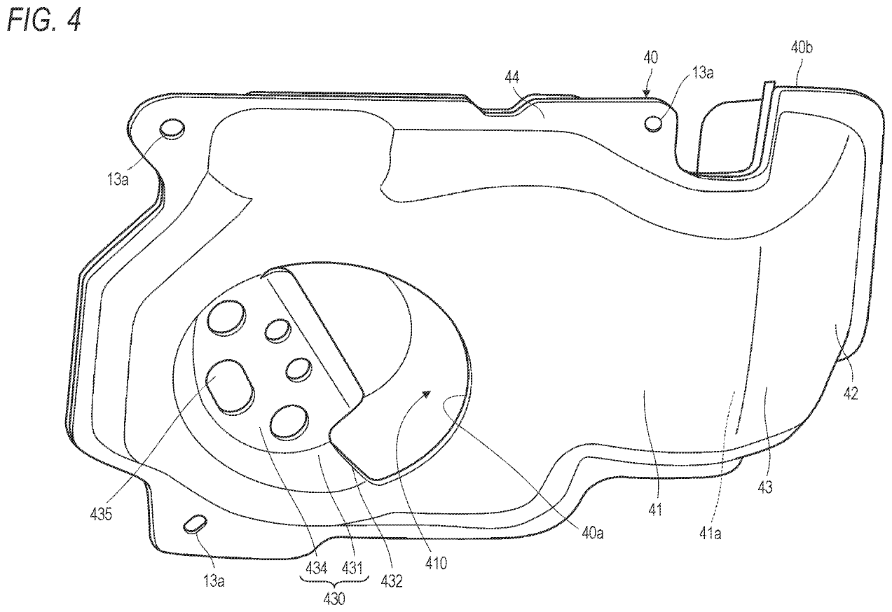

The downstream duct member 40 is a substantially L-shaped duct when viewed from the front side. As shown in FIGS. 3 and 4, the downstream duct member 40 includes an opening 40a which is connected to and communicates with the fan 12, and an introduction portion 40b that introduces the cooling air into the inside. The opening 40a is opened downward and communicates with the suction port 12a of the fan 12 from above via a sealing member 90 (see FIG. 7). The introduction portion 40b is opened upward and is connected to the upstream duct member 30.

The downstream duct member 40 is constituted by an upper member 40A and a lower member 40B. The lower member 40B includes the opening 40a described above and is connected to the fan 12. The upper member 40A is attached to the lower member 40B from above. The upper member 40A and the lower member 40B are in contact with each other at outer edge portions thereof extending in the horizontal direction, are bonded with an adhesive or the like, and define a flow path communicating with the fan 12.

The downstream duct member 40 includes a horizontal portion 41, a vertical portion 42, and a bent portion 43. The horizontal portion 41 extends in the horizontal direction above the fan 12. The vertical portion 42 extends in the vertical direction along the right surface of the battery module 11. An upper end of the vertical portion 42 is the introduction portion 40b described above, and is connected to the upstream duct member 30. The bent portion 43 connects the horizontal portion 41 and the vertical portion 42. The bent portion 43 changes the traveling direction of the cooling air flowing in the vertical portion 42 from the vertical direction to the horizontal direction, and guides the cooling air to the horizontal portion 41.

Three fixing portions 13a are provided on a contact portion 44 at the outer edge portions of the upper member 40A and the lower member 40B of the downstream duct member 40. Each of the fixing portions 13a has an insertion hole through which a fastening means such as a pin-shaped clip (not shown) can be inserted, for example. The downstream duct member 40 is fixed to the base plate 171 by inserting a clip into the fixing portions 13a and a fixing portion (not shown) provided on the base plate 171. Note that the fastening means may be bolts or the like. Fixing of the downstream duct member 40 to the base plate 171 is not limited to these methods, and any fixing method can be adopted.

The downstream duct member 40 is made of a nonwoven fabric. Specifically, the upper member 40A and the lower member 40B are formed by pressing a sheet-like nonwoven fabric, and the upper member 40A and the lower member 40B are bonded to form the downstream duct member 40. The nonwoven fabric has excellent sound absorption performance, and absorbs acoustic energy of drive noise generated when the fan 12 is driven and fluid noise generated when the cooling air flows. By forming the downstream duct member 40 communicating with the fan 12 from a nonwoven fabric, the drive noise of the fan 12 can be absorbed, and the drive noise traveling through the intake duct 13 and leaking from the intake port 17a into the vehicle interior can be reduced. An outer surface of the downstream duct member 40 is covered with a laminate film to prevent the cooling air inside the downstream duct member 40 from leaking to the outside.

Next, among flow paths formed inside the downstream duct member 40, a flow path formed inside the horizontal portion 41 will be described in detail.

The downstream duct member 40 includes the introduction portion 40b and the opening 40a described above, a curved flow path 410, a rectifying portion 420, and a guide portion 430.

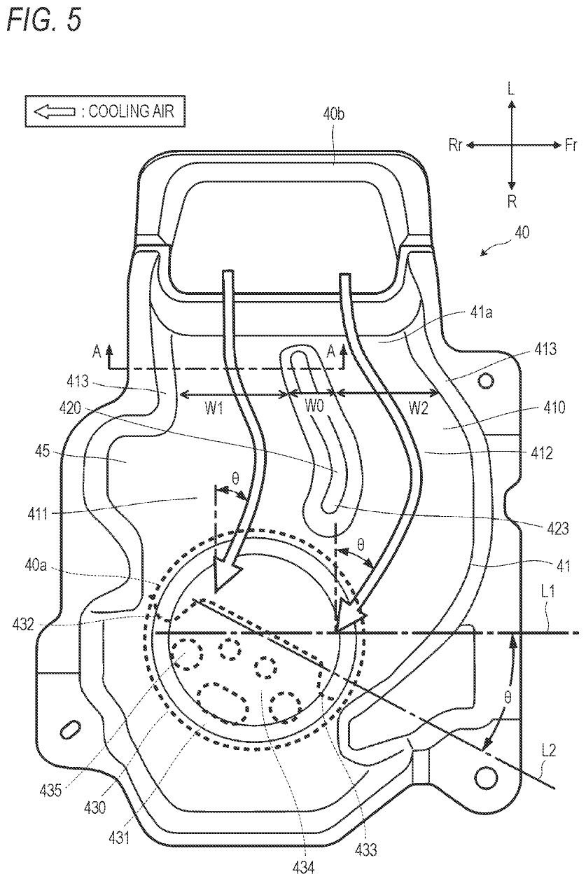

As shown in FIG. 5, the curved flow path 410 is provided from an inlet 41a communicating with the bent portion 43 to the opening 40a communicating with the fan 12. The curved flow path 410 extends in a curved shape in a plane (in a horizontal plane in the present embodiment) perpendicular to the rotation axis direction of the fan 12. In the plane perpendicular to the rotation axis direction of the fan 12, the inlet 41a and the opening 40a are provided at positions overlapping with each other in the front-rear direction.

To describe the curved flow path 410 in more detail, the curved flow path 410 extends substantially linearly in the left-right direction in a vicinity of the inlet 41a. The curved flow path 410 extends forward in an arc shape on a downstream side of the vicinity of the inlet 41a. More specifically, a side wall portion 413 defining the curved flow path 410 extends forward in an arc shape. The cooling air flowing along such an arcuate curve flows into the opening 40a at a predetermined angle θ greater than zero with respect to the direction in which the horizontal portion 41 extends (here, the left-right direction).

The rectifying portion 420 extends in a curved shape along the curved flow path 410 and rectifies the cooling air flowing through the curved flow path 410. The rectifying portion 420 is provided at approximately a center of the curved flow path 410 in the width direction (front-rear direction in the drawing), and similarly to the curved flow path 410, extends forward in an arc shape.

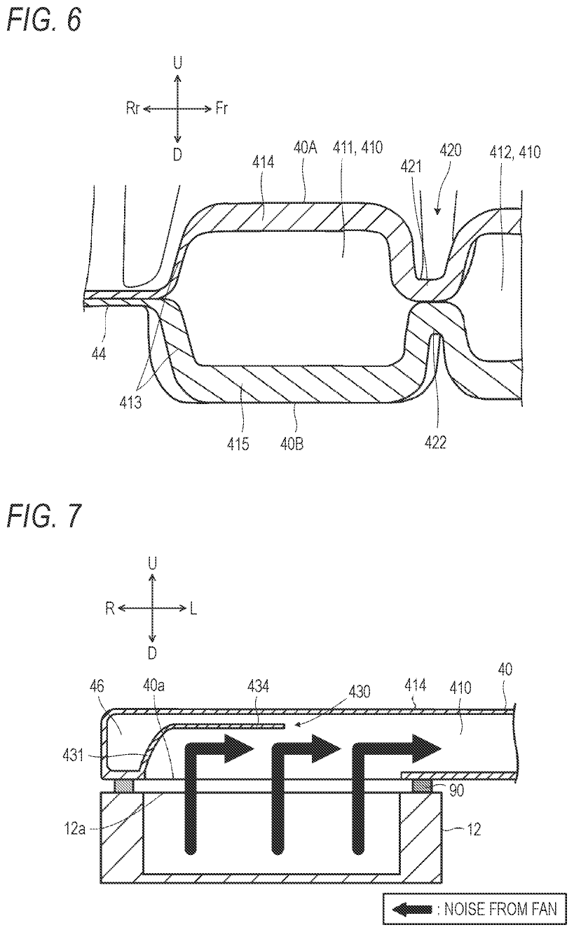

As shown in FIG. 6, the rectifying portion 420 is formed by bringing an upper recess 421, in which an upper wall portion 414 of the upper member 40A of the downstream duct member 40 is recessed toward the lower member 40B, and a lower recess 422, in which a lower wall portion 415 of the lower member 40B is recessed toward the upper member 40A, into contact with each other.

The rectifying portion 420 divides the curved flow path 410 into two. As shown in FIG. 5, the curved flow path 410 includes an inner curved flow path 411 positioned inside the rectifying portion 420 having a curved shape and an outer curved flow path 412 positioned outside of the rectifying portion 420 having a curved shape. The cooling air flowing through the inner curved flow path 411 and the outer curved flow path 412 both flow along the rectifying portion 420. Although details will be described later, since the guide portion 430 provided in the opening 40a is provided facing a flow direction of the cooling air, the cooling air flowing through the inner curved flow path 411 and the cooling air flowing through the outer curved flow path 412 are approximately parallel to each other and flow into the fan 12. In this case, the cooling air flows into the fan 12 at the predetermined angle θ with respect to the direction in which the horizontal portion 41 extends (left-right direction). When the cooling air flowing through the inner curved flow path 411 and the cooling air flowing through the outer curved flow path 412 flow into the fan 12, the flow directions thereof are substantially parallel to each other, so that a pressure loss is small and the cooling air can smoothly flow into the fan 12.

As shown in FIG. 4, the guide portion 430 is provided in the opening 40a of the downstream duct member 40, and guides the cooling air flowing through the curved flow path 410 to the opening 40a. The guide portion 430 is formed by, for example, recessing a part of a lower surface of the lower member 40B of the downstream duct member 40 upward. That is, the guide portion 430 is provided integrally with the downstream duct member 40.

The guide portion 430 includes a guide wall 431 and a top plate portion 434, as shown in FIGS. 4, 5, and 7.

The guide wall 431 is erected from a part of an outer edge portion of the opening 40a and receives the cooling air flowing through the curved flow path 410. In the present embodiment, the guide wall 431 is provided on a right side part of the outer edge portion of the opening 40a. In a direction along the outer edge portion of the opening 40a (that is, in a circumferential direction), the guide wall 431 is provided in a range of approximately 180° in the circumferential direction from one side end portion 432 to the other side end portion 433. The guide wall 431 is erected at an angle from the outer edge portion of the opening 40a.

The top plate portion 434 is provided at an upper end of the guide wall 431 and is provided facing the opening 40a and the fan 12. The top plate portion 434 covers a part (in the present embodiment, a right half) of the opening 40a.

The top plate portion 434 is provided with a gap between the top plate portion 434 and the upper wall portion 414 of the upper member 40A. The top plate portion 434 is provided with a plurality of through holes 435.

As shown in FIG. 5, the guide portion 430 is provided on a downstream side of the curved flow path 410 and facing the direction in which the cooling air flows. In this case, the guide portion 430 faces a downstream end portion 423 of the rectifying portion 420. Here, for more detailed description, a straight virtual line passing through a center of the opening 40a and extending in a direction (here, the front-rear direction) perpendicular to a direction in which the horizontal portion 41 extends is defined as L1, and a virtual line linearly connecting the one side end portion 432 and the other side end portion 433 of the guide wall 431 is defined as L2. The guide portion 430 is provided so that an angle formed by the virtual line L1 and the virtual line L2 is a predetermined angle θ. This angle θ is equal to the angle θ with respect to the direction in which the horizontal portion 41 extends when the cooling air flows into the opening 40a. In other words, the guide portion 430 is provided so that the virtual line L2 and the flow direction of the cooling air flowing into the opening 40a are perpendicular to each other when viewed from the rotation axis direction of the fan 12.

Since the guide portion 430 is provided facing the direction in which the cooling air flows, the cooling air flowing through the curved flow path 410 can be smoothly guided to the fan 12 without increasing the pressure loss.

As described above, the outer surface of the downstream duct member 40 is covered with a laminate film (not shown). Since the guide portion 430 is formed by recessing the lower surface, which is the outer surface, of the lower member 40B upward, the surface of the guide portion 430 that faces the curved flow path 410 (that is, an inner surface of the guide wall 431 and the lower surface of the top plate portion 434) is covered with a laminate film. Unlike the nonwoven fabric, the laminate film does not absorb acoustic energy, and instead reflects sound.

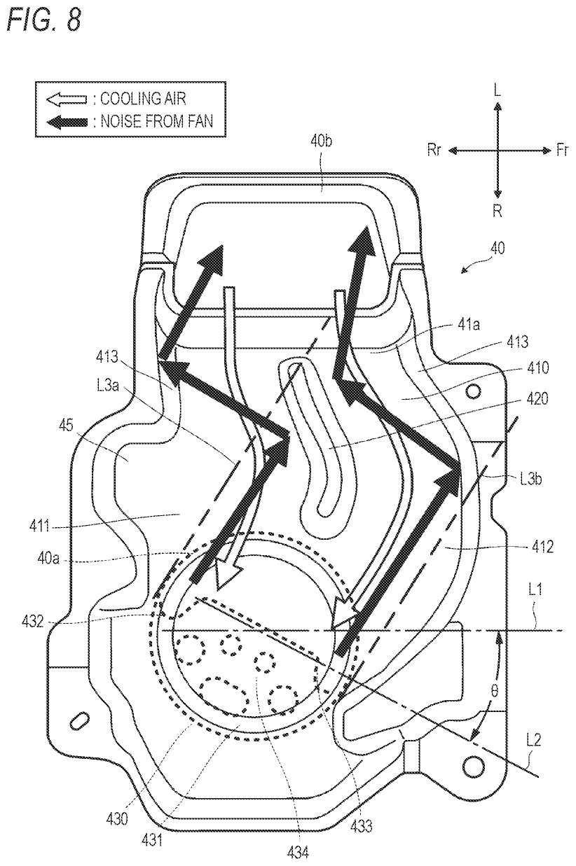

Therefore, as shown in FIG. 7, the noise generated by the fan 12 (such as the drive noise of the fan 12) is reflected by the guide portion 430 and travels within the curved flow path 410. Furthermore, as shown in FIG. 8, the noise from the fan 12 reflected by the guide portion 430 travels intensively in a direction toward which the guide portion 430 faces, that is, in a direction perpendicular to the virtual line L2.

In the present embodiment, in the plane perpendicular to the rotation axis direction of the fan 12 (here, in a horizontal plane), when viewed from the opening 40a in the direction perpendicular to the virtual line L2, the inlet 41a of the curved flow path 410 is at an invisible position.

Specifically, since the rectifying portion 420 is positioned on a virtual line L3a extending from the one side end portion 432 of the guide wall 431 in the direction perpendicular to the virtual line L2, when viewed in a direction along the virtual line L3a from the opening 40a, the inlet 41a is at an invisible position. Since the side wall portion 413 is positioned on a virtual line L3b extending from the other side end portion 433 of the guide portion 430 in the direction perpendicular to the virtual line L2, when viewed in a direction along the virtual line L3b from the opening 40a, the inlet 41a is at an invisible position. That is, the noise generated by the fan 12 is reflected by the guide portion 430 and travels in the direction perpendicular to the virtual line L2, and then is reflected at least once by the rectifying portion 420 and/or the side wall portion 413 before reaching the inlet 41a.

Since the downstream duct member 40 made of nonwoven fabric has high sound absorption performance, the noise generated by the fan 12 is attenuated by being reflected by the rectifying portion 420 and/or the side wall portion 413. Therefore, the drive noise of the fan 12 reaching the inlet 41a can be reduced, and as a result, the noise leaking into the vehicle interior from the intake port 17a can be reduced. As described above, the downstream duct member 40 can guide the cooling air to the fan 12 without increasing the pressure loss, so that the downstream duct member 40 is a duct member with small pressure loss and high sound absorption performance.

Furthermore, after the noise generated by the fan 12 is attenuated in the plane perpendicular to the rotation axis direction of the fan 12, the noise generated by the fan 12 can be further attenuated by being reflected by the bent portion 43. Therefore, the noise leaking into the vehicle interior from the intake port 17a can be further reduced.

The inner curved flow path 411 is provided with a convex space 45 that bulges out from the inner curved flow path 411 around the opening 40a and further inside the inner curved flow path 411. The convex space 45 bulges out to the inside (here, the rear side) of the inner curved flow path 411.

When a part of the noise generated by the fan 12 travels from the opening 40a to the convex space 45, the noise that enters the convex space 45 is repeatedly reflected within the convex space 45. As a result, the noise that enters the convex space 45 is greatly attenuated. In other words, the convex space 45 can collect and attenuate the noise generated by the fan 12. As a result, the noise from the fan 12 reaching the inlet 41a can be reduced, and the noise leaking into the vehicle interior from the intake port 17a can be reduced.

Since the cooling air flowing through the inner curved flow path 411 flows along the rectifying portion 420 positioned outside of the inner curved flow path 411, the cooling air does not flow much at a position further inside the inner curved flow path 411. Even when the convex space 45 is provided further inside the inner curved flow path 411, the flow of the cooling air is hardly affected, and an increase in the pressure loss can be prevented.

Among the noise generated by the fan 12, high-frequency noise is greatly attenuated by being reflected by the rectifying portion 420 and the side wall portion 413. On the other hand, among the noise generated by the fan 12, low-frequency noise is more difficult to be attenuated than the high-frequency noise even by being reflected by the rectifying portion 420 and the side wall portion 413. However, if a volume of a space through which the low-frequency noise travels is increased, the low-frequency noise is likely to be diffused and attenuated.

Therefore, in the present embodiment, as shown in FIG. 5, in the direction perpendicular to the flow direction of the cooling air, a width W0 of the rectifying portion 420 is smaller than a width W1 of the inner curved flow path 411 and a width W2 of the outer curved flow path 412. By reducing the width W0 of the rectifying portion 420 in this way, a volume of the curved flow path 410 becomes large, and the low-frequency noise becomes easier to be attenuated.

Note that a part of the noise generated by the fan 12 passes through the plurality of through holes 435 provided in the guide portion 430 and enters a space 46 above and to the right of the guide portion 430 (see FIG. 7). The noise generated by the fan 12 is attenuated by being repeatedly reflected within this space 46.

Although an embodiment of the present invention has been described above with reference to the accompanying drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, respective constituent elements in the above embodiment may be freely combined without departing from the gist of the invention.

For example, in the embodiment described above, the downstream duct member 40 is formed by nonwoven fabric, and the nonwoven fabric is associated with the sound absorbing material provided on the downstream duct member 40, but the present invention is not limited thereto. The downstream duct member 40 may be formed by, for example, resin, and a sound absorbing material may be separately provided on an inner surface of the downstream duct member 40.

In the present description, at least the following matters are described. In the parentheses, the corresponding constituent elements and the like in the embodiment described above are shown as an example, but the present invention is not limited thereto.

(1) A duct structure (intake duct 13) connected to a fan (fan 12) that blows cooling air to a battery (battery module 11) mounted on a vehicle (vehicle V), the duct structure including:
a duct member (downstream duct member 40) connected to the fan, in which the duct member includes:
an introduction portion (introduction portion 40b) introducing the cooling air,
an opening (opening 40a) communicating with the fan,
a curved flow path (curved flow path 410) having the opening and extending in a curved shape in a plane perpendicular to a rotation axis direction of the fan,
a rectifying portion (rectifying portion 420) extending in a curved shape along the curved flow path and rectifying the cooling air flowing through the curved flow path, and
a guide portion (guide portion 430) provided in the opening and guiding the cooling air flowing through the curved flow path to the opening,
a sound absorbing material is provided in the curved flow path,
the guide portion includes a guide wall (guide wall 431) erected from a part of an outer edge portion of the opening and receiving the cooling air flowing through the curved flow path, and
an inlet (inlet 41a) of the curved flow path connected to the introduction portion is disposed at a position that is not visible in the plane perpendicular to the rotation axis direction of the fan when viewed in a direction perpendicular to a virtual line (virtual line L2) connecting one side end portion (one side end portion 432) and the other side end portion (the other side end portion 433) of the guide wall from the opening in a straight line.

According to (1), the noise generated by the fan is attenuated by being reflected by the wall portion of the curved flow path and the rectifying portion before reaching the inlet of the curved flow path in the plane perpendicular to the rotation axis direction of the fan. In this way, the noise generated by the fan can be sufficiently reduced within the duct member.

(2) The duct structure according to (1), in which
the curved flow path includes an inner curved flow path (inner curved flow path 411) positioned inside the rectifying portion and an outer curved flow path (outer curved flow path 412) positioned outside the rectifying portion, and
the inner curved flow path is provided with a space (convex space 45) that bulges out from the inner curved flow path to a periphery of the opening and a further inside of the inner curved flow path.

According to (2), by collecting and attenuating the noise generated by the fan in the space bulging out from the inner curved flow path, the noise generated by the fan can be sufficiently reduced within the duct member. Since the space is provided further inside the inner curved flow path, the space does not affect the flow of the cooling air.

(3) The duct structure according to (1) or (2), in which
the curved flow path includes an inner curved flow path (inner curved flow path 411) positioned inside the rectifying portion and an outer curved flow path (outer curved flow path 412) positioned outside the rectifying portion, and
a width (width W0) of the rectifying portion is smaller than a width (width W1) of the inner curved flow path and a width (width W2) of the outer curved flow path in a direction perpendicular to a flow direction of the cooling air.

The larger the volume of the flow path, the easier it is to attenuate low-frequency noise. According to (3), the volume of the curved flow path is increased by reducing the width of the rectifying portion, so that the effect of attenuating low-frequency noise among the noise generated by the fan can be enhanced.

(4) The duct structure according to any one of (1) to (3), in which
the duct member includes:
a flow path (flow path in the vertical portion 42) having the introduction portion and extending in the rotation axis direction of the fan, and
a bent portion (bent portion 43) connecting the flow path extending in the rotation axis direction and the inlet of the curved flow path.

According to (4), since the direction of the flow path changes by 90° at the bent portion, the noise generated by the fan can be further reflected and attenuated at the bent portion.

(5) The duct structure according to any one of (1) to (4), in which
the duct member is made of a nonwoven fabric, and
the sound absorbing material provided in the curved flow path is the nonwoven fabric of the duct member.

According to (5), by forming the duct member of a nonwoven fabric which is a sound absorbing material, the noise generated by the fan can be sufficiently reduced within the duct member.

What is claimed is:

1. A duct structure connected to a fan that blows cooling air to a battery mounted on a vehicle, the duct structure comprising:
a duct member connected to the fan, wherein
the duct member includes:
an introduction portion introducing the cooling air,
an opening communicating with the fan,
a curved flow path having the opening and extending in a curved shape in a plane perpendicular to a rotation axis direction of the fan,
a rectifying portion extending in a curved shape along the curved flow path and rectifying the cooling air flowing through the curved flow path, and
a guide portion provided in the opening and guiding the cooling air flowing through the curved flow path to the opening,
a sound absorbing material is provided in the curved flow path,
the guide portion includes a guide wall erected from a part of an outer edge portion of the opening and receiving the cooling air flowing through the curved flow path, and
an inlet of the curved flow path connected to the introduction portion is disposed at a position that is not visible in the plane perpendicular to the rotation axis direction of the fan when viewed in a direction perpendicular to a virtual line connecting one side end portion and the other side end portion of the guide wall from the opening in a straight line.

2. The duct structure according to claim 1, wherein
the curved flow path includes an inner curved flow path positioned inside the rectifying portion and an outer curved flow path positioned outside the rectifying portion, and
the inner curved flow path is provided with a space that bulges out from the inner curved flow path to a periphery of the opening and a further inside of the inner curved flow path.

3. The duct structure according to claim 1, wherein
the curved flow path includes an inner curved flow path positioned inside the rectifying portion and an outer curved flow path positioned outside the rectifying portion, and
a width of the rectifying portion is smaller than a width of the inner curved flow path and a width of the outer curved flow path in a direction perpendicular to a flow direction of the cooling air.

4. The duct structure according to claim 1, wherein
the duct member includes:
a flow path having the introduction portion and extending in the rotation axis direction of the fan, and
a bent portion connecting the flow path extending in the rotation axis direction and the inlet of the curved flow path.

5. The duct structure according to claim 1, wherein
the duct member is made of a nonwoven fabric, and
the sound absorbing material provided in the curved flow path is the nonwoven fabric of the duct member.
